(19) United States
(12) Patent Application Publication
(10) Pub. No.: US 2010/0114913 A1
(43) Pub. Date: May 6, 2010

(54) DOCUMENT PROCESSING DEVICE, DOCUMENT PROCESSING METHOD, AND DOCUMENT PROCESSING PROGRAM

(75) Inventors: Shingo Ochi, Tokushima-shi (JP); Takanori Hino, Tokushima-shi (JP); Shingo Hada, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, Tokushima-shi, Tokushima (JP)

(21) Appl. No.: 12/443,323

(22) PCT Filed: Sep. 28, 2007
(86) PCT No.: PCT/JP2007/001064

§ 371 Date: Mar. 27, 2009

(30) Foreign Application Priority Data
Sep. 29, 2006 (JP) 2006-267887

(51) Int. Cl. G06F 17/30

(52) U.S. Cl. 707/749; 707/741; 707/E17.044; 707/E17.008

(57) ABSTRACT

A document processing apparatus according to the present embodiment handles a structured document file described in XML, XHTML, and HTML, etc., as a document to be processed. The document processing apparatus selects a base tag and a comparison tag from a structured document file, and computes a positional proximity between the two tags in a hierarchical structure as a tag-proximity degree. The apparatus specifies a comparison tag with a tag-proximity degree of a predetermined threshold value or more with respect to the base tag, as a proximity-tag. The apparatus outputs the data specified by one or more of the proximity-tags, as the proximity-data with respect to the base tag.

### FIELD OF THE INVENTION

The present invention relates to a document processing technique, in particular, to an information retrieval technique in which a structured document file is processed.

### BACKGROUND ART

With the growing use of computers and the progress of the networking techniques, there has been an increase in electronic information exchange via network. In this background, a lot of paperwork that is conventionally paper-based has been replaced by network-based processing. In particular, a number of document files have recently been created as structured document files referred to as XML (eXtensible Markup Language), HTML (Hyper Text Markup Language), or XHTML (eXtensible HyperText Markup Language). The progress of the networking techniques and the growing use of structured document files excellent in information retrieval performance has drastically lowered the cost for information acquisition.

Patent Document 1: Japanese Patent Laid-Open No. 2006-048536

### DISCLOSURE OF THE INVENTION

### Problem to be Solved by the Invention

In a document retrieval process, a data retrieval condition is usually inputted to specify a document file including the data that meets the retrieval condition. When a document is specified, a user confirms whether the requested information is truly present in the document by reading the content of the document. The present inventors have focused their attention on a user's burden involved in reading the document, and have formed a view that, to enhance the efficiency of acquiring information to a higher level, a technique in which the information included in a document file is effectively presented to a user is important as well as a technique in which the document file having a high probability of including the requested information is specified more accurately.

The present invention has been completed based on the above inventors' view, and a general purpose of the invention is to provide a technique in which the information to be presented to a user is reasonably selected from the information included in a structured document file.

### Means for Solving the Problem

A document processing apparatus according to an embodiment of the present invention, handles a structured document file described in XML, XHTML, and HTML, etc., as a document to be processed. The apparatus selects a base tag and a comparison tag from a structured document file, and computes a positional proximity between the two tags in a hierarchical structure as a tag-proximity degree. The apparatus specifies a comparison tag with a tag-proximity degree of a predetermined threshold value or more with respect to the base tag, as a proximity-tag. The apparatus outputs the data specified by one or more of the proximity-tags as the proximity-data with respect to the base tag.

Herein, the “output” may be an image output to be displayed on a screen, or an output to be transmitted to another device via a telecommunication line. When a user is interested in the information specified by the base tag (hereinafter, referred to as “information of interest”), not only the information of interest but also the information highly relevant to the information of interest can be provided to the user by outputting the proximity-data. In other words, the information less relevant to the information of interest can be easily excluded. Various topics included in a structured document file can be arranged, sorted, and hierarchized by a hierarchical structure of tags; hence, with the use of a document processing apparatus according to the embodiment stated above, a range of the information highly relevant to the information of interest specified by the base tag, can be reasonably specified.

It is noted that any combination of the aforementioned components or any manifestation of the present invention realized by modification of a method, system, program, recoding medium, and so forth, is effective as an embodiment of the present invention.

### Advantage of the Invention

According to the present invention, the information that a user is highly interested in, can be easily provided to the user from the information included in a structured document file.

### BRIEF DESCRIPTION OF THE DRAWINGS

An Embodiment will now be described by way of example only, with reference to the accompanying drawings that are meant to be exemplary, not limiting, in which:

FIG. 1 is a diagram illustrating a retrieval screen of a document processing apparatus;

FIG. 2 is a diagram illustrating an example of a structured document file;

FIG. 3 is a functional block diagram of the document processing apparatus;

FIG. 4 is a diagram illustrating an example of a hierarchical structure of tags in a certain structured document file;

FIG. 5 is a flow chart illustrating processes from acquisition of a retrieval condition to output of the proximity-data; and

FIG. 6 is a diagram illustrating another example of a hierarchical structure of tags in a certain structured document file.

### REFERENCE NUMERALS

100 DOCUMENT PROCESSING APPARATUS

110 USER INTERFACE PROCESSOR

112 INPUT UNIT

114 DISPLAY UNIT

120 DATA PROCESSOR

122 BASE TAG SELECTION UNIT

124 COMPARISON TAG SELECTION UNIT

126 PROXIMITY-DATA SPECIFICATION UNIT

128 TAG-PROXIMITY DEGREE COMPUTING UNIT

130 COMMON TAG SPECIFICATION UNIT

132 DEPTH-ELEMENT-VALUE COMPUTING UNIT

134 ORDER-ELEMENT-VALUE COMPUTING UNIT

136 INTEGRATED COMPUTING UNIT

140 DOCUMENT MEMORY UNIT

150 STRUCTURED DOCUMENT FILE

152 BASE REGION

154 RELEVANT INFORMATION REGION

160 RETRIEVAL SCREEN

170 RETRIEVAL STRING INPUT REGION

180 RETRIEVAL BUTTON

182 DOCUMENT FILE TITLE COLUMN

184 CONTENT DISPLAY REGION

186 PAGE CHANGE BUTTON

### BEST MODE FOR CARRYING OUT THE INVENTION

The document processing apparatus 100 according to the present embodiment has a function that sets a relevant information region around the information of interest in a structured document file and displays on the screen only the proximity-data included in the relevant information region. Herein, the information of interest may be any information specified by a user; however, on the premise that the information of interest meets a retrieval condition, a description will be made below.

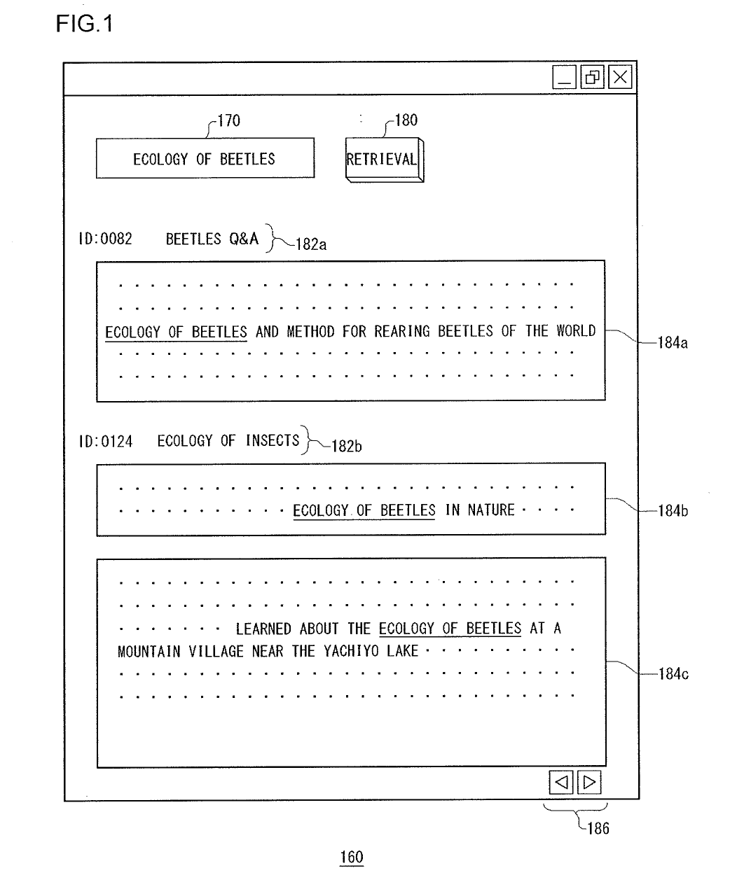

FIG. 1 is a diagram illustrating a retrieval screen 160 of the document processing apparatus 100. When a user inputs a retrieval string in the retrieval string input region 170 and clicks the retrieval button 180, the document processing apparatus 100 retrieves a document file including the retrieval string from a certain group of document files. In the diagram, a document file including the retrieval string of “ecology of beetles” is detected. A structured document file thus detected is referred to as a “detected document”.

The title of the detected document is displayed in the document file title columns 182a and 182b. Also, part of the content of the detected document is displayed in the content display regions 184a to 184c. In the diagram, part of the detected document titled “Beetles Q&A” with the document ID of 0082, is displayed in the content display region 184a; part of the detected document with the document ID of 0124, “Ecology of Insects”, is displayed in the content display region 184b; and another part of the same is displayed in the content display region 184c. This is because the retrieval string of “ecology of beetles” is detected at two places in the detected document titled “Ecology of Insects” with the document ID of 0124. In the diagram, only two detected documents are displayed. A user can change a detected document to be displayed to another by clicking the page change button 186.

In the content display region 184, a content surrounding the place where the retrieval string of “ecology of beetles” appears is also displayed with respect to each detected document. Therefore, a user can confirm, in each detected document, which context the retrieval string of “ecology of beetles” is used in, on the retrieval screen 160 without actually opening the document. In order to enhance the convenience in retrieving information by the document processing apparatus 100, it is an important issue how much information is to be displayed in the content display region 184.

When a lot of information is displayed in the content display region 184, a user can more easily understand the content of each detected document on the retrieval screen 160, while the user's burden of confirming the content per one detected document is large. Also, the number of the detected documents that can be displayed on the screen 160 at a time, is small. There is also a disadvantage that there is a high probability of the information less relevant to the information of interest being displayed. On the other hand, when limiting the information to be displayed in the content display region 184, the user's burden is small, while it is difficult for the user to understand the content of each detected document only with the retrieval screen 160. The document processing apparatus 100 according to the present embodiment specifies a volume or a range of the information to be displayed in the content display region 184 based on a hierarchical structure of tags in a detected document. Prior to an explanation of a specific processing method, an explanation with respect to the relevant information region in a detected document will be made below.

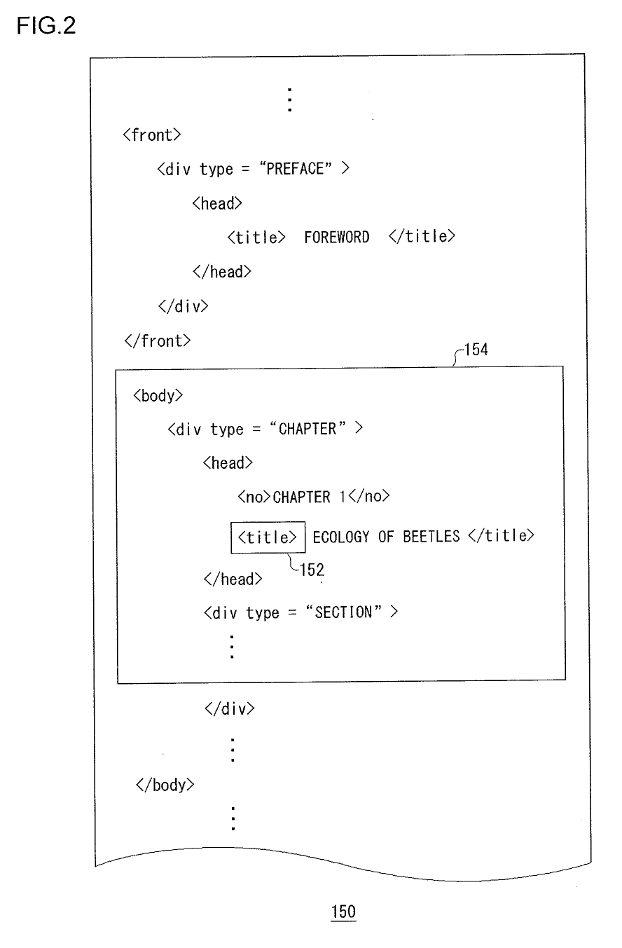

FIG. 2 is a diagram illustrating an example of a structured document file 150. In the present embodiment, a document file to be processed in the present embodiment is a structured document file structured by tags, as is in an XML file and an XHTML file. The structured document file 150 illustrated in the diagram is an XTHML file. In the document file, the retrieval string of “ecology of beetles” is present in the element data of the tag <title> in the path expression of “//body/div/head/title”. The document processing apparatus 100 specifies the tag <title> as a “base tag”, and a position where the basic tag is positioned is referred to as a base region 152. Hereinafter, the data relevant to a tag such as the element data, an attribute, an attribute value, or the title of a certain tag, or a range of such data is referred to as a “scope” of the tag. In the case of the structured document file 150 illustrated in the diagram, the scope of the base tag <title> is “<title> ecology of beetles </title>” in which the retrieval string is included. In a similar manner, the scope of the higher tag <head> is “<head> . . . </head>” which covers the scopes of the tag <no> and the tag <title>.

The relevant information region 154 is specified by a processing method, which is described later, based on the position of the base tag <title>. In the case of the structured document file 150 illustrated in the diagram, the scope of the tag <head> in the path expression of “//body/div/head”, is included in the relevant information region 154, while the scope of the tag <head> in the path expression of “//front/div/head” is not included therein. In addition, only part of the scope of the tag <body> in the path expression of “//body” is included in the relevant information region 154. An object to be displayed in the content display region 184 is the data included in the relevant information region 154 (hereinafter, referred to as the “proximity-data”). Hereinafter, the structure of the document processing apparatus 100 is described below followed by the description with respect to the processing method for specifying the relevant information region 154.

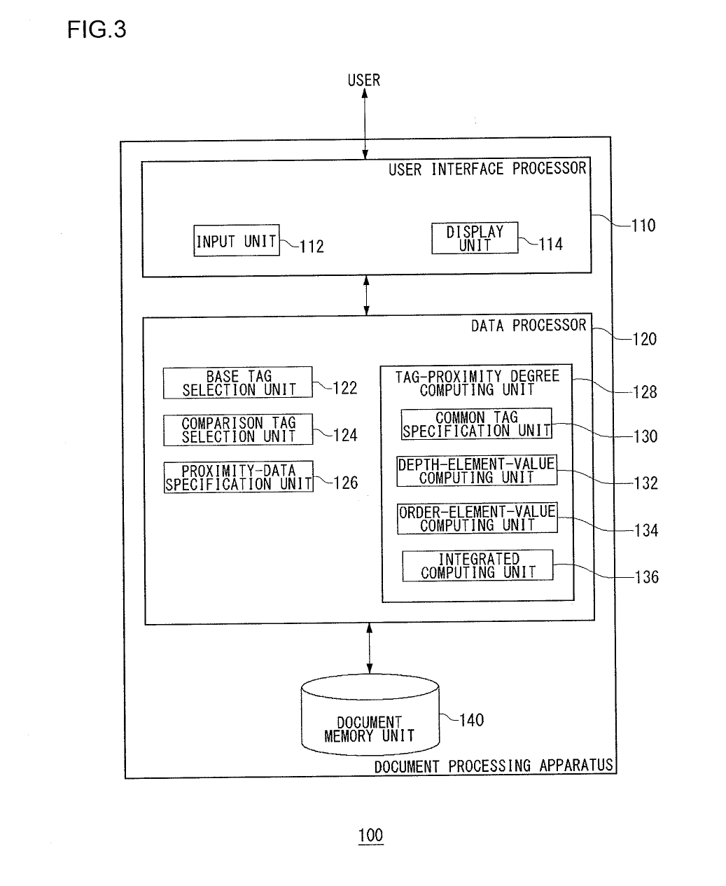

FIG. 3 is a functional block diagram of the document processing apparatus 100. Each block illustrated herein is implemented in hardware by any CPU of a computer, other elements, and mechanical devices, and implemented in software by a computer program or the like. FIG. 3 depicts functional blocks implemented by the cooperation of hardware and software. Therefore, it will be obvious to those skilled in the art that these functional blocks may be implemented in a variety of manners by a combination of hardware and software.

The document processing apparatus 100 comprises: a user interface processor 110; a date processor 120; and a document memory unit 140. The user interface processor 110 is in charge of processes with regard to a general user interface such as processing an input from a user and displaying information to the user. In the present embodiment, on the premise that a user interface service of the document processing apparatus 100 is provided by the user interface processor 110, a description will be made below. As another embodiment, a user may manipulate the document processing apparatus 100 via the Internet. In the case, a communication unit (not illustrated) receives manipulation-instruction information from a user terminal and transmits the information on a processing result executed based on the manipulation-instruction to the user terminal. The document memory unit 140 holds structured document files to be retrieved.

The data processor 120 executes various data processing based on the data acquired from the user interface processor 110 and the document memory unit 140. The data processor 120 also plays a role of an interface between the user interface processor 110 and the document memory unit 140.

The use interface processor 110 comprises an input unit 112 and a display unit 114. The input unit 112 receives an input manipulation from a user. The display unit 114 displays various information to the user. The retrieval screen 160 illustrated in FIG. 1 is displayed on the screen by the display unit 114. A retrieval condition is acquired via the input unit 112. The retrieval condition may also be designated as a tag path expression such as an XPath expression that is a sentence structure based on XPath (XML Path Language). Alternatively, the retrieval condition may be designated as a retrieval string. The retrieval string may be detected from an attribute value, an attribute title, and a tag title, without limiting to the element data. At any rate, a retrieval condition may be any condition that the data to be retrieved should meet.

The data processor 120 comprises: a base tag selection unit 122; a comparison tag selection unit 124; a proximity-data specification unit 126; and a tag-proximity degree computing unit 128. The base tag selection unit 122 detects a document file including the data meeting a retrieval condition (hereinafter, referred to as the “data to be retrieved”) from the document memory unit 140 to select as a base tag the tag of which scope includes the data to be retrieved. The comparison tag selection unit 124 sequentially selects tags other than the base tag from the detected document. The tag selected by the comparison tag selection unit 124 is referred to as a “comparison tag”. However, a so-called “end tag” such as </head>, is excluded from the tags to be selected as comparison tags.

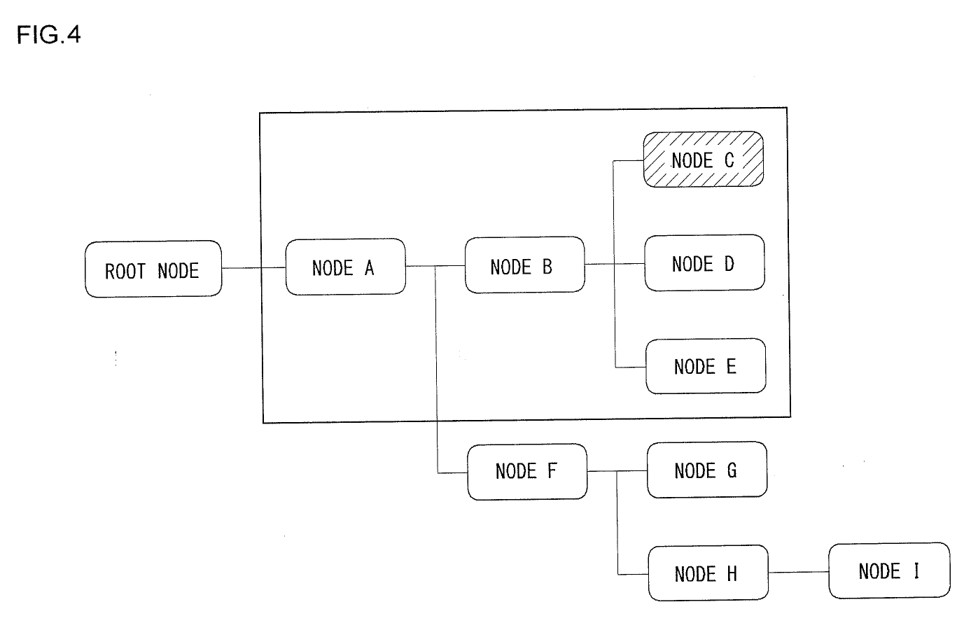

The tag-proximity degree computing unit 128 indexes a positional proximity between a base tag and a comparison tag in a hierarchical structure as a “tag-proximity degree”, with the use of a processing method described later. The proximity-data specification unit 126 specifies a tag with a tag-proximity degree of a predetermined threshold value T or more, that is, a tag at a position somewhat close to a base tag as a “proximity-tag”. In the case of the structured document file 150 illustrated in FIG. 2, the tag <head> in “//body/div/head” is to be specified as a proximity-tag. The proximity-data specification unit 126 specifies a relevant information region based on the scope of the proximity-tag. The data included in the relevant information region is referred to as the “proximity-data”. A relation between the scope of the proximity-tag and the relevant information region will be described in detail with reference to FIG. 4. In the content display region 184, the display unit 114 screen-displays the proximity-data in the relevant information region.

The tag-proximity degree computing unit 128 comprises: a common tag specification unit 130, a depth-element-value computing unit 132, an order-element-value computing unit 134, and an integrated computing unit 136. Among parent tags of a base tag and a comparison tag, the common tag specification unit 130 specifies as a “common tag” a tag at the deepest position in a hierarchical structure of tags, when seen from a root node. For example, in the case of the structured document file 150 illustrated in FIG. 2, on the premise that the tag <no> in “//body/div/head/no” is a comparison tag, the parent tags of the base tag <title> in “//body/div/head/title” and the comparison tag <no>, are <head>, <div>, and <body>. Among these, the tag at the deepest position when seen from the route node, is the tag <head> in “//body/div/head”; hence, the tag <head> becomes a common tag.

The depth-element-value computing unit 132 computes a depth-element-value, and the order-element-value computing unit 134 computes an order-element-value. The integrated computing unit 136 computes a tag-proximity degree from the depth-element-value and the order-element-value. Computation formulae for the depth-element-value, the order-element-value, and the tag-proximity degree, are as follows:

[symbol]

[Equation 1]

Equation (1) is a computation formula for computing a tag-proximity degree Near(n₁, n₂) between a base tag n₁ and a comparison tag n₂. The Near Depth (n₁, n₂) indicates a depth-element-value as a proximity-degree in relation to the depth of the base tag n₁ and that of the comparison tag n₂. The Near_Width(n₁, n₂) indicates an order-element-value as a proximity-degree in relation to the path of the base tag n₁ and that of the comparison tag n₂. β is any number of 0 or more to 1 or less. The integrated computing unit 136 computes a tag-proximity degree Near(n₁, n₂) by taking weighted average of a depth-element-value Near_Depth (n₁, n₂) and an order-element-value Near Width(n₁, n₂), in accordance with β. That is, the tag-proximity degree Near(n₁, n₂) is a value that becomes larger as the depth-element-value Near_Depth (n₁, n₂) is larger, and similarly becomes larger as the order-element-value Near_Width(n₁, n₂) is larger.

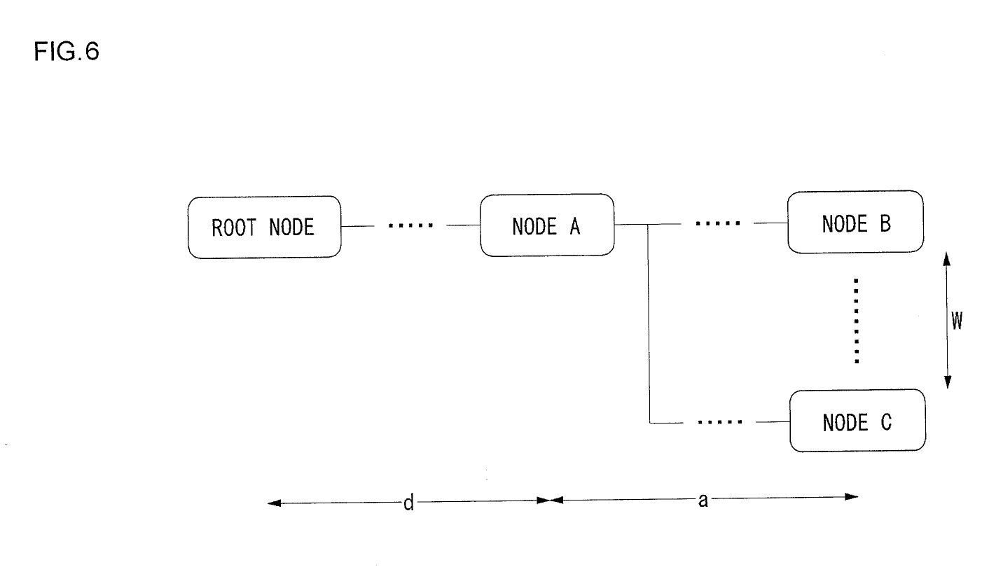

Equation (2) is a computation formula for computing the depth-element-value Near_Depth (n₁, n₂). Herein, the depth (n) indicates a depth of the tag n in a tag hierarchy, when a tag hierarchy of a root node is 0. For example, in the case of the path expression of “/A/B/C/D”, the depth of the tag <A> is “1” and that of the tag <D> is “4”. The common (n₁, n₂) represents the common tag between the base tag n₁ and the comparison tag n₂. The depth-element-value Near_Depth (n₁, n₂) becomes larger as the common tag is at a deeper position, and as the depth difference between the depth of the common tag and that of the base tag n₁, and the depth difference between the depth of the common tag and that of the comparison tag n₂ are smaller. That is, the depth-element-value of the base tag n₁ and the comparison tag n₂ becomes larger, when the base tag n₁ and the comparison tag n₂ are at deeper positions in a tag hierarchy, and have a closer relation with each other in relation to their depth. With regard to the depth-element-value, a discussion will be further made later with reference to FIG. 6.

Equation (3) is a computation formula for computing an order-element-value Near_Width (n₁, n₂). α is any number of 1 or more. The brotherhood (n₁, n₂) indicates the closeness between the path from the common tag to the base tag n₁ and the path from the common tag to the comparison tag n₂. For example, in a tag structure as follows,

```
<A>
  <B>
  <C>....</C>
  <D>... </D>
  <E>....</E>
  </B>
</A>
```

a common tag between the tag <C> and the tag <D>, and a common tag between the tag <C> and the tag <E>, are both tag <B>. The path from the tag <B> to the tag <C> and the path from the tag <C> to the tag <D> are adjacent to each other. In the case, the brotherhood (C, D) is “1”. Contrary to that, the path from the tag <B> to the tag <D> is sandwiched between the path from the tag <B> to the tag <C> and that from the tag <B> to the tag <E>. In the case, the brotherhood (C, E) is “2”. That is, the brotherhood (n₁, n₂) is a value obtained by adding 1 to the number of the paths present between the path to the basic tag n₁ and the path to the comparison tag n₂. The common tag between the tag <B> and the tag <C> is the tag <B>, and the two tags are lined up on the same path expression as is in “//A/B/C”. In this case, the brotherhood (B, C) is “0”.

The order-element-value Near_Width (n₁, n₂) is larger, as the common tag is at a deeper position, and as the path from the common tag to the base tag n₁ and the path from the common tag to the comparison tag n₂, have a closer relation with each other. That is, the order-element-value Near_Width (n₁, n₂) becomes larger, when the base tag n₁ and the comparison tag n₂ are at deeper positions in a tag hierarchy, and have a closer relation with each other in relation to their paths. With regard to the order-element-value, a discussion will be further made with reference to FIG. 6. Next, the processes in which a tag-proximity degree is really computed based on the above Equation (1) and the relevant information region is specified, will be exemplified below.

FIG. 4 is a diagram illustrating an example of a hierarchical structure of tags in a predetermined structured document file. A node is a unit of data specified based on a tag in a structured document file, and a description will be made on the premise that a node has the same meaning as a tag, unless otherwise indicated. Herein, a description will be made on the premise that a tag of the node C (hereinafter simply denoted as the “tag C”) is the base tag. In addition, it is assumed that α=2 and β=0.5.

### Node D (Tag D):

When the comparison tag selection unit 124 selects a tag D as a comparison tag, the common tag specification unit 130 specifies the tag B as a common tag. In the case, the depth of the tag C and the tag D are both “3” and that of the tag B is “2”; therefore, the depth-element-value Near_Depth (C, D)=(2×2/(3+3))=⅔ holds. In addition, other path is not present between the path from the common tag B to the tag C and the path from the common tag B to the tag D, therefore the brotherhood (C, D)=“1” holds. Accordingly, the order-element-value Near_Width (C, D)=(2̂2/(1+1))=2 holds. “̂” represents a power method. From what stated above, a tag-proximity degree Near(C, D)=0.5×(⅔)+0.5×(2)=4/3=1.33 . . . holds.

### Node E (Tag E):

When the comparison tag selection unit 124 selects the tag E as a comparison tag, the common tag specification unit 130 specifies the tag B as a common tag. Between the path from the common tag B to the tag C and the path from the common tag B to the tag E, there is present the path from the common tag B to the tag D; hence the brotherhood (C, D) is “2”. Accordingly, the tag-proximity degree Near(C, E)=0.5×(2×2/(3+3))+0.5×(2̂2/(1+2))=1 holds.

### Node B(Tag B):

When the comparison tag selection unit 124 selects the tag B as a comparison tag, the common tag specification unit 130 specifies the tag B as a common tag. The tag B and tag C are lined up on the same path, hence the brotherhood (C, B) is “0”. Accordingly, the tag-proximity degree Near(C, B)=0.5×(2×2/(2+3))+0.5×(2̂2/(1+0))=2.4 holds.

### Node A (Tag A):

The tag-proximity degree Near(C, A)=0.5×(2×1/(1+3))+0.5×(1̂2/(1+0))=0.75 holds.

### Root Node (Root Tag):

The tag-proximity degree Near(C, root)=0.5×(2×0/(0+3))+0.5×(0̂2/(1+0))=0 holds.

### Node F (Tag F):

When the comparison tag selection unit 124 selects the tag F as a comparison tag, the common tag specification unit 130 specifies the tag A as a common tag. The path from the common tag A to the tag C and that from the common tag A to the F, branch off each other in the path to the tag B and in the path to the tag F. In the case, the brotherhood (C, F) is set to 1. Accordingly, the tag-proximity degree Near(C, F)=0.5×(2×1/(2+3))+0.5×(1̂2/(1+1))=0.45 holds. Hereinafter, the tag-proximity degrees are computed in the same manner.

### Node G (Tag G):

The tag-proximity degree Near(C, G)=0.5×(2×1/(3+3))+0.5×(1̂2/(1+1))=0.416 . . . holds.

### Node H (Tag H):

The tag-proximity degree Near(C, H)=0.5×(2×1/(3+3))+0.5×(1̂2/(1+1))=0.416 . . . holds.

### Node I (Tag I):

The tag-proximity degree Near(C, I)=0.5×(2×1/(3+4))+0.5×(1̂2/(1+1))=0.392 . . . holds.

Herein, assuming that the threshold value T of the tag-proximity degree is 0.5, the proximity-data specification unit 126 specifies the tags A, B, D, and E as the proximity-data in relation to the base tag C. The proximity-data, in other words, the relevant information region is specified by the following conditions.

1. When a certain proximity-tag α does not have a child tag, all data in the scope of the proximity-tag α is included in the proximity-data.

2. When a certain proximity-tag β has children tags, the data in the tags from the start-tag of the proximity-tag β to the tag immediately before the start-tag of the first child tag are included in the proximity-tag. However, when all children tags in the proximity-tag β are proximity-tags, all the data in the scope of the proximity-tag β is included in the proximity-tag.

Accordingly, in the case of the tag structure illustrated in the diagram, the tag structure is as follows:

```
<A>
  <B>
  <C></C>
  <D></D>
  <E></E>
  </B>
  <F>
  <G></G>
  <H>
    <I></I>
  </H>
  </F>
</A>.
```

Hence, the range of “<A> . . . </B>” becomes the relevant information region. That is, the data included in part of the scope of the tag <A> and the data included in all of the scope of the tag <B> become the proximity-data.

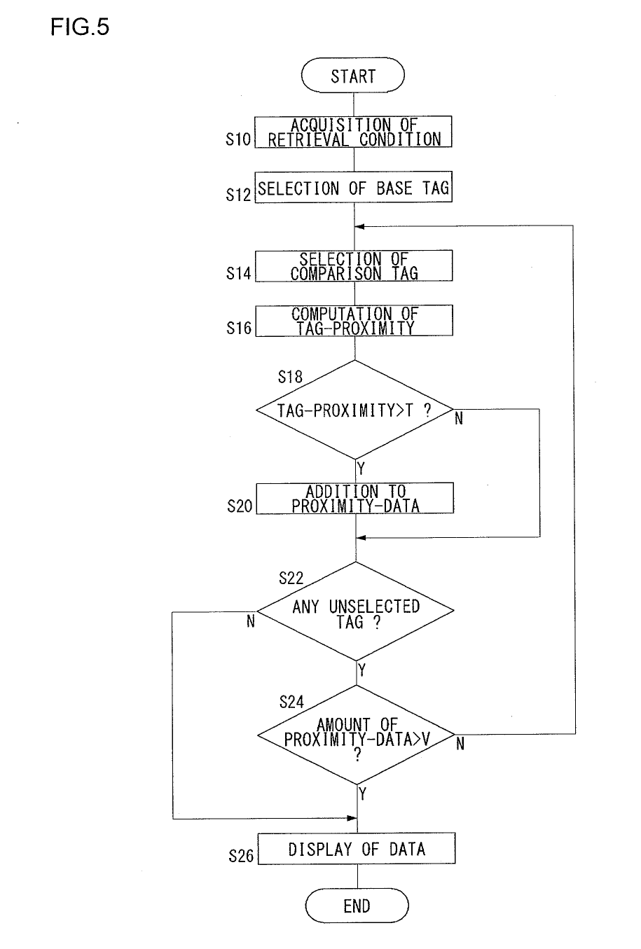

FIG. 5 is a flowchart illustrating the processes from acquisition of a retrieval condition to output of the proximity-data. When the input unit 112 acquires a retrieval condition (S10), the base tag selection unit 122 selects a base tag after specifying the document file including the data to be retrieved (S12). The comparison tag selection unit 124 selects a comparison tag from the detected document (S14). The tag-proximity degree computing unit 128 computes a tag-proximity degree between the base tag and the comparison tag based on the above computation formula (S16). When the tag-proximity degree is a predetermined threshold value T or more (S18/Y), the proximity-data specification unit 126 not only specifies the comparison tag as a proximity-tag but also adds part or all of the data in the scope of the proximity-tag as a proximity-tag (S20). When the tag-proximity degree is less than the threshold value T (S18/N), the S20 processing is skipped.

When a tag that is not selected in S14 is present in the detected document (S22/Y), and a data amount of the proximity-tag is a predetermined value V or less (S24/N), the process returns to S14 to select a next comparison tag (S14). Herein, the data amount of the proximity-data may be any one of the number of lines, the number of characters, the number of sentences, and the number of bytes of the proximity-data. That is, it is prevented by the threshold value V that an amount of the information to be displayed in the content display region 184 is not too large. When an unselected tag is not present (S22/N), or the data amount of the proximity-data exceeds the threshold value V (S24/Y), the display unit 114 displays the proximity-data in the content display region 184. The display unit 114 may display the title of the proximity-tag instead of the proximity-data or in addition to that. Finally, a general property of the depth-element-value and the order-element-value will be described.

FIG. 6 is a diagram illustrating another example of a hierarchical structure of tags in a certain structured document file. Herein, it is assumed that a common tag between the tag B and the tag B is the tag A of which depth is d, and the depth from the tag A to the tag B and to the tag C is a, and the brotherhood (B, C) is “w”.

### [Depth-Element-Value]

### Between the Parent Tag and the Child Tag (Tag A and Tag B):

The depth-element-value between the tag A and the tag B, which have a parent-child relationship, is computed as follows: the depth-element-value Near_Depth (A, B)=2×d/(d+d+a)=2d/(2d+a) holds. The depth-element-value Near_Depth (A, C) is also computed in the same way.

### Between Tags Having a Sibling Relationship (Tag B and Tag C):

The depth-element-value between the tag B and the tag C, which have a sibling relationship, is computed as follows: the depth-element-value Near_Depth (B, C)=2×d/(d+a+d+a)=d/(d+a) holds. In any case, the depth-element-value becomes larger as d is larger and a is smaller; however, the depth-element-value never takes a value of 1 or larger.

### [Order-Element-Value]

### Between the Parent Tag and the Child Tag (Tag A and Tag B):

The order-element-value between the tag A and the tag B, which have a parent-child relationship, is computed as follows: the order-element-value Near_Width (A, B)=d̂A2/(1+0)=d̂2. The depth-element-value Near_Width (A, C) is also computed in the same way. The depth-element-value becomes larger, possibly infinite, as d is larger.

### Between Tags Having a Sibling Relationship (Tag B and Tag C):

The order-element-value between the tag B and the tag C, which have a sibling relationship, is computed as follows: the order-element-value Near_Width (B, C)=d̂2/(1+w). The depth-element-value becomes larger, possibly infinite, as d is larger and w is smaller.

The tag-proximity degree is computed by taking weighted average of the depth-element-value and the order-element-value; therefore, the tag-proximity degree becomes larger, possibly infinite, as d is larger and a and w are smaller. That is, the -proximity degree becomes larger, as the common tag is at a deeper position, the base tag and the comparison tag are closer to each other in terms of the depth when seen from the common tag, and the path from the common tag to the base tag and that from the common tag to the comparison tag are closer to each other.

Usually, a hierarchical structure of tags specifies a sentence structure in many cases, hence the content of a document is structured by the hierarchical structure of tags to some extent. For example, there are many cases where, as a common tag is at a deeper position, the information indicated in the scope of the common tag is more detailed and concretized. In addition, there are many cases where, as a base tag and a comparison tag are at closer positions relative to the common tag in terms of the depth and the path, the information in the scope of the base tag and the information in the scope of the comparison tag, are closely related with each other among the information included in the scope of the common tag. Based on these perceptions, the document processing apparatus 100 can reasonably specify the range of the proximity-data on the basis of a hierarchical structure of tags.

The present invention has been explained based on the embodiments. These embodiments are intended to be illustrative only and it will be obvious to those skilled in the art that various modifications to constituting elements and processes could be developed and that such modifications are also within the scope of the present invention.

For example, when a data amount of the proximity-data specified based on a predetermined threshold value T is less than a certain value W, the proximity-data specification unit 126 may change the setting of the threshold value T to a smaller value. According to such processing method, it can be prevented that a data amount of the proximity-data becomes too small. From the same reason, the proximity-data specification unit 126 may also adjust a data amount of the proximity-data by dynamically changing the values of α and β.

A user may appropriately adjust α, β and threshold values T and V via the input unit 112. For example, by setting the threshold value T to a smaller one and the threshold value V and α to larger ones, respectively, with respect to a predetermined document file, the range of the relevant information region can be enlarged. In addition, the proximity-data specification unit 126 may change the range of the proximity-data in accordance with the screen size and the resolution of the retrieval screen 160. For example, when an information amount per one screen is relatively small as is in a mobile terminal, the range of the proximity-data is narrowed, and when an information amount per one screen is large as is in a PC monitor, the range thereof is widened; with the above operation, the size of the proximity-data can be preferably adjusted in accordance with a user's environment.

It will be obvious to those skilled in the art that the function to be achieved by each constituent requirement described in the claims may be achieved by each functional block shown in the exemplary embodiments or by a combination of the functional blocks.

### INDUSTRIAL APPLICABILITY

According to the present invention, a user can be easily provided with the information in which he/she is highly interested from the information included in a structured document file.

1. A document processing apparatus comprising:
a base tag selection unit that selects a base tag from a structured document file in which a position of data is specified by a path expression based on a hierarchical structure of tags, as a tag to be retrieved;
a comparison tag selection unit that selects a comparison tag from the structured document file, as a tag to be compared;
a tag-proximity degree computing unit that computes a positional proximity between the base tag and the comparison tag in the hierarchical structure in the structured document file, as a tag-proximity degree, by using a predetermined computing formula;
a proximity-tag specification unit that specifies a comparison tag with a tag-proximity degree of a predetermined threshold value or more, as a proximity-tag; and
a proximity-data output unit that outputs the data specified by one or more of the proximity-tags as the proximity-data with respect to the base tag, in the structured document file.

2. The document processing apparatus according to claim 1, further comprising a retrieval condition input unit that receives an input of a retrieval condition that the data to be retrieved should meet, wherein the base tag selection unit selects a tag that meets the retrieval condition, as a base tag.

3. The document processing apparatus according to claim 1, wherein the comparison tag selection unit selects a new comparison tag on condition that a data amount of the proximity-data already specified is a predetermined value or less.

4. The document processing apparatus according to claim 1, wherein the tag-proximity degree computing unit comprises: a common tag specification unit that specifies a common parent tag of the base tag and the comparison tag, which is closest to both tags, as a common tag; a depth-element-value computing unit that computes a depth-element-value by a predetermined monotonically increasing function with respect to the depth of the common tag in the hierarchical structure of tags; an order-element-value computing unit that computes an order-element-value by a predetermined monotonically decreasing function with respect to the number of passes present between the path from the common tag to the base tag and that from the common tag to the comparison tag; and an integrated computing unit that computes a tag-proximity degree by a predetermined monotonically increasing function with respect to the depth-element-value and the order-element-value, respectively.

5. A method for processing a document comprising:
selecting a base tag from a structured document file in which a position of data is specified by a path expression based on a hierarchical structure of tags, as a tag to be retrieved;
selecting a comparison tag from the structured document file, as a tag to be compared;
computing a positional proximity between the base tag and the comparison tag in the hierarchical structure in the structured document file, as a tag-proximity degree, by using a predetermined computing formula;
specifying a comparison tag with a tag-proximity degree of a predetermined threshold value or more as a proximity-tag; and
outputting the data specified by one or more of the proximity-tags as the proximity-data with respect to the base tag, in the structured document file.

6. A document processing computer program product comprising:
a module that selects a base tag from a structured document file in which a position of data is specified by a path expression based on a hierarchical structure of tags, as a tag to be retrieved;
a module that selects a comparison tag from the structured document file, as a tag to be compared;
a module that computers a positional proximity between the base tag and the comparison tag in the hierarchical structure in the structured document file, as a tag-proximity degree, by using a predetermined computing formula;
a module that specifies a comparison tag with a tag-proximity degree of a predetermined threshold value or more as a proximity-tag; and
a module that outputs the data specified by one or more of the proximity-tags as the proximity-data with respect to the base tag, in the structured document file.
